(19) United States
(12) Patent Application Publication
(10) Pub. No.: US 2024/0231622 A9
(43) Pub. Date: Jul. 11, 2024

(54) RESOLVING DEDUPLICATION MATCHES WHEN USING NON-CRYPTOGRAPHIC HASH

(71) Applicant: Dell Products L.P., Round Rock, TX (US)

(72) Inventors: Alexander Shknevsky, Fair Lawn, NJ (US); Uri Shabi, Tel Mond (IL); Aleksey Kabishcher, Marlborough, MA (US)

(21) Appl. No.: 17/972,039

(22) Filed: Oct. 24, 2022

(51) Int. Cl. G06F 3/06; G06F 16/215

(52) U.S. Cl. CPC G06F 3/061; G06F 3/0641; G06F 3/068; G06F 16/215

(57) ABSTRACT

A technique for managing deduplication using a non-cryptographic hash function includes obtaining metadata associated with both a candidate block presented for deduplication and a target block having a hash-based match to the candidate block. The technique further includes checking for a mismatch between the candidate block and the target block based on the obtained metadata. In response to the checking determining a mismatch, the technique further includes abandoning deduplication of the candidate block, such that the candidate block is stored independently of the target block.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” service storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

Many storage systems provide data reduction facilities, such as compression and deduplication. Compression removes redundant content from data blocks, such that compressed data blocks are normally smaller in size than are the uncompressed data blocks from which the compressed data blocks are generated. Data storage systems typically use lossless compression, such that exact original versions of data can be regenerated from corresponding compressed data. Compression may be run in software or in hardware. Many different software compression algorithms are known, such as Lempel-Ziv (LZ) compression and Lempel-Ziv-Welch (LZW) compression, both of which are available in different strengths. Stronger algorithms provide higher compression ratios but generally involve longer compute times.

Deduplication also removes redundant content, but it operates at coarser granularity than does compression, such as at the block level. A “block” is a unit of allocatable storage space in a storage system. Blocks may have uniform size, such as 4 kB (kilo-Bytes) or 8 kB, for example. Deduplication generally proceeds block by block. For instance, a deduplication facility computes a hash value of a given block (a “candidate block”) and performs a lookup into a digest table for a “target block” having a matching hash value. Depending on the entropy of hash values, a match between the two hash values may conclusively confirm a match between the two data blocks. If a match is found, the deduplication facility may effectuate storage of the candidate block by pointing a logical representation of the candidate block to the data of the target block. In this manner, both the candidate block and the target block share the same data, and redundant storage of the data of the candidate block is avoided.

### SUMMARY

Hash functions used for deduplication may be cryptographic or non-cryptographic. Cryptographic hash functions have sufficiently high entropy that they are guaranteed to produce no hash collisions, meaning that it is statistically impossible for the same hash value to be computed from two different data blocks. Such cryptographic hash functions can involve tradeoffs, however, as they normally require long compute times and produce long hash values, which can consume considerable storage space. In contrast, non-cryptographic hash functions are much faster to compute and produce shorter hash values, but they are not guaranteed to avoid hash collisions. Thus, a deduplication facility that uses a non-cryptographic hash function must generally perform an additional step of data validation, to ensure that matching hash values truly indicate matching data blocks. Such validation may involve byte-for-byte comparisons of actual data of candidate blocks and corresponding target blocks.

Unfortunately, byte comparisons following hash-based matches can consume significant time and resources. This can be especially the case when data blocks are stored in compressed form, as it may be necessary to decompress the data blocks before comparing them. What is needed is a more efficient way of determining whether data blocks match when using non-cryptographic hash functions for deduplication.

To address this need at least in part, an improved technique for managing deduplication using a non-cryptographic hash function includes obtaining metadata associated with both a candidate block presented for deduplication and a target block having a hash-based match to the candidate block. The improved technique further includes checking for a mismatch between the candidate block and the target block based on the obtained metadata. In response to the checking determining a mismatch, the technique further includes abandoning deduplication of the candidate block, such that the candidate block is stored independently of the target block.

Advantageously, the improved technique rapidly disqualifies many preliminary matches made using non-cryptographic hash-based comparisons, and thus operates faster and more efficiently than prior approaches, which may rely on data decompression and byte-for-byte comparisons.

Certain embodiments are directed to a method of managing deduplication. The method includes preliminarily matching a candidate block to a target block using a non-cryptographic hash function, as part of an attempted deduplication of the candidate block. The method further includes identifying a mismatch between the candidate block and the target block based on comparing metadata of the candidate block with metadata of the target block, and canceling the attempted deduplication of the candidate block responsive to the comparing indicating the mismatch.

In some examples, comparing the metadata includes determining whether a checksum of the candidate block matches a checksum of the target block, the comparing being configured to indicate the mismatch responsive to the checksum of the candidate block not matching the checksum of the target block.

In some examples, the candidate block and the target block are both compressed blocks, and the checksum of the candidate block and the checksum of the target block are included within respective footers of the compressed blocks.

In some examples, the checksum of the candidate block and the checksum of the target block are each computed based on uncompressed data of the candidate block and the target block, respectively.

In some examples, the candidate block and the target block are both compressed blocks, and comparing the metadata of the candidate block with the metadata of the target block includes: identifying, from the metadata of the candidate block, a first compression method used to compress the candidate block and a first compressed size of the candidate block; identifying, from the metadata of the target block, a second compression method used to compress the target block and a second compressed size of the target block; and in response to determining that the first compression method matches the second compression method, determining whether the first compressed size matches the second compressed size, the comparing configured to indicate the mismatch responsive to the first compression method matching the second compression method but the first compressed size not matching the second compressed size.

In some examples, comparing the metadata of the candidate block with the metadata of the target block includes both (i) determining whether a checksum of the candidate block matches a checksum of the target block, and (ii) determining whether a compressed size of the candidate block matches a compressed size of the target block, the comparing configured to indicate the mismatch responsive to at least one of (i) the checksum of the candidate block not matching the checksum of the target block or (ii) the compressed size of the candidate block not matching the compressed size of the target block.

In some examples, the method further includes: preliminarily matching a second candidate block to a second target block using the non-cryptographic hash function, as part of an attempted deduplication of the second candidate block; further preliminarily matching the second candidate block with the second target block by determining that metadata of the second candidate block matches metadata of the second target block; comparing a set of compressed data of the second candidate block with a corresponding set of compressed data of the second target block; and abandoning the attempted deduplication of the second candidate block responsive to the set of compressed data of the second candidate block failing to match the corresponding set of compressed data of the second target block.

In some examples, the method further includes preliminarily matching a second candidate block to a second target block using the non-cryptographic hash function, as part of an attempted deduplication of the second candidate block, the second candidate block and the second target block both being compressed. In such examples, the method further includes determining that a compression method used for compressing the second candidate block matches a compression method used for compressing the second target block, and confirming a true match between the second candidate block and the second target block responsive to a compressed-data match between the second candidate block and the second target block.

In some examples, comparing metadata of the candidate block with metadata of the target block includes comparing metadata that deterministically provides identical results for identical data.

Other embodiments are directed to a computerized apparatus constructed and arranged to perform a method of managing deduplication, such as the method described above. Still other embodiments are directed to a computer program product. The computer program product stores instructions which, when executed on control circuitry of a computerized apparatus, cause the computerized apparatus to perform a method of managing deduplication, such as the method described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views.

FIG. 1 is a block diagram of an example environment in which embodiments of the improved technique can be practiced.

FIG. 2 is a flowchart showing an example method of attempting deduplication of a compressed data block.

FIG. 3 is a block diagram of an example layout of a compressed data block.

FIG. 4 is a flowchart showing an example method of performing optimized checks.

FIG. 5 is a flowchart showing an example method of managing deduplication.

### DETAILED DESCRIPTION

Embodiments of the improved technique will now be described. One should appreciate that such embodiments are provided by way of example to illustrate certain features and principles but are not intended to be limiting.

An improved technique for managing deduplication using a non-cryptographic hash function includes obtaining metadata associated with both a candidate block presented for deduplication and a target block having a hash-based match to the candidate block. The improved technique further includes checking for a mismatch between the candidate block and the target block based on the obtained metadata. In response to the checking determining a mismatch, the technique further includes abandoning deduplication of the candidate block, such that the candidate block is stored independently of the target block.

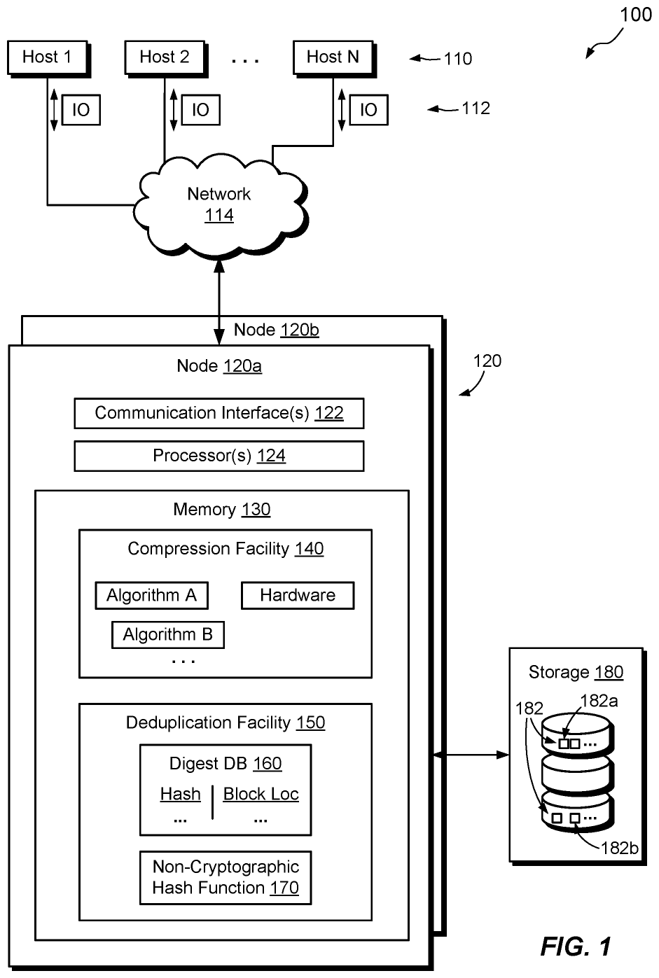

FIG. 1 shows an example environment 100 in which embodiments of the improved technique can be practiced. Here, multiple hosts 110 are configured to access a data storage system 116 over a network 114. The data storage system 116 includes one or more nodes 120 (e.g., node 120a and node 120b), and storage 180, such as magnetic disk drives, electronic flash drives, optical drives, and/or the like. Nodes 120 may be provided as circuit board assemblies or blades, which plug into a chassis (not shown) that encloses and cools the nodes. The chassis has a backplane or midplane for interconnecting the nodes 120, and additional connections may be made among nodes 120 using cables. In some examples, the nodes 120 are part of a storage cluster, such as one which contains any number of storage appliances, where each appliance includes a pair of nodes 120 connected to shared storage. In some arrangements, a host application runs directly on the nodes 120, such that separate host machines 110 need not be present. No particular hardware configuration is required, however, as any number of nodes 120 may be provided, including a single node, in any arrangement, and the node or nodes 120 can be any type or types of computing device capable of running software and processing host I/O's.

The network 114 may be any type of network or combination of networks, such as a storage area network (SAN), a local area network (LAN), a wide area network (WAN), the Internet, and/or some other type of network or combination of networks, for example. In cases where separate hosts 110 are provided, such hosts 110 may connect to the node 120 using various technologies, such as Fibre Channel, iSCSI (Internet small computer system interface), NVMeOF (Nonvolatile Memory Express (NVMe) over Fabrics), NFS (network file system), and CIFS (common Internet file system), for example. As is known, Fibre Channel, iSCSI, and NVMeOF are block-based protocols, whereas NFS and CIFS are file-based protocols. The node 120 is configured to receive I/O requests 112 according to block-based and/or file-based protocols and to respond to such I/O requests 112 by reading or writing the storage 180.

The depiction of node 120a is intended to be representative of all nodes 120. As shown, node 120a includes one or more communication interfaces 122, a set of processors 124, and memory 130. The communication interfaces 122 include, for example, SCSI target adapters and/or network interface adapters for converting electronic and/or optical signals received over the network 114 to electronic form for use by the node 120a. The set of processors 124 includes one or more processing chips and/or assemblies, such as numerous multi-core CPUs (central processing units). The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 130 “includes,” i.e., realizes by execution of software instructions, a compression facility 140 and a deduplication facility 150. The compression facility 140 is configured to compress and decompress data blocks 182, such as those found in storage 180 or in memory 130. The compression facility 140 may allow for a variety of software-based compression algorithms (e.g., Algorithm A, Algorithm B, Algorithm C, etc.), which provide different levels of compression, for example. In some cases, the compression facility 140 supports hardware-based compression, e.g., using co-processors or other specialized chips or assemblies. Such hardware compression may itself provide different compression levels. As used herein, the term “compression method” refers to a compression algorithm or hardware technology, along with a compression level, and thus includes both software-based compression and hardware-based compression. Although the depicted compression facility 140 may support a variety of compression methods, some embodiments may support only a single compression method.

The deduplication facility 150 is configured to perform data deduplication, such as block-based deduplication. To deduplicate a particular data block 182a (a candidate block), the deduplication facility 150 may hash the data block to generate a hash value and then perform a lookup for that hash value in a digest database 160. For example, the digest database 160 associates hash values of data blocks with associated locations of those data blocks in the storage system. The hash values may be computed from compressed data blocks or from uncompressed data blocks. A matching entry to a target block 182b listed in the digest database 160 identifies a potential block match. If the hash function is cryptographic, then the potential match is determined conclusively to be a true match. In such cases, the deduplication facility 150 effectuates storage of the candidate block 182a by reference to the target block 182b, e.g., by establishing a pointer between a logical address of the candidate block and the data of the target block, as indicated by the block location listed for the target block in the digest database 160. But if the hash function is non-cryptographic, then the potential match must typically be confirmed before deduplication can proceed.

In accordance with improvements hereof, a preliminary (potential) match between a candidate block 182a and a target block 182b is evaluated at least in part by comparing metadata of the candidate block 182a with corresponding metadata of the target block 182b. In some examples, such metadata may be provided in the respective data blocks themselves, such as in headers or footers of the data blocks, which may be compressed. Alternatively, such metadata may be provided in other locations associated with the data blocks, such as in block-pointer metadata or in virtual-block metadata, both of which are typically accessed in a data path traversed when reading the data block. The metadata may include any number of information elements, such as a checksum of the data block, e.g., a cyclic redundancy check (CRC), which is preferably computed from uncompressed data of the data block. Other examples of such metadata include a compressed size of the data block and a compression method used to compress the data block, for example.

Although comparing metadata of a candidate block with that of a target block cannot be solely relied upon to confirm a non-cryptographic hash-based match in many cases, such comparing can be used to quickly disqualify a potential match. For example, if the checksum of the candidate block 182a does not match the checksum of the target block 182b, then it can be concluded with certainty that the two blocks do not match (assuming the same checksum method is used for both blocks). Further, if the two blocks were compressed using the same compression method but have different compressed sizes, then it can also be concluded that the two blocks do not match, as a true match would have produced identical compressed sizes for the same compression method. Thus, by comparing metadata of the candidate block with that of the target block, a potential match can be quickly disqualified, saving considerable time and computing resources that might otherwise be spent comparing data, such as by using byte-for-byte comparisons.

Checksums and compressed sizes provide excellent examples of metadata that can be compared to disqualify potential block matches, but embodiments are not limited to these types of metadata. Indeed, any type of metadata that deterministically provides the same results for the same data provides a suitable basis for comparison. Further, it is not required that the metadata be unique to the particular data of the data block, as the role of the metadata is to disqualify rather than to confirm potential matches.

If the metadata comparison as described above disqualifies a potential match between a candidate block 182a and a target block 182b, then deduplication does not proceed and the candidate block 182a is instead stored independently of the target block 182b. If the candidate block 182a had previously been placed in storage 180, then the candidate block 182a may simply be left where it originally resided. But if the candidate block 182a previously existed only in memory 130, then the candidate block 182a may be stored in a new location in storage 180. If the metadata comparison fails to disqualify the potential match, then additional acts may be performed to confirm or disqualify the match conclusively.

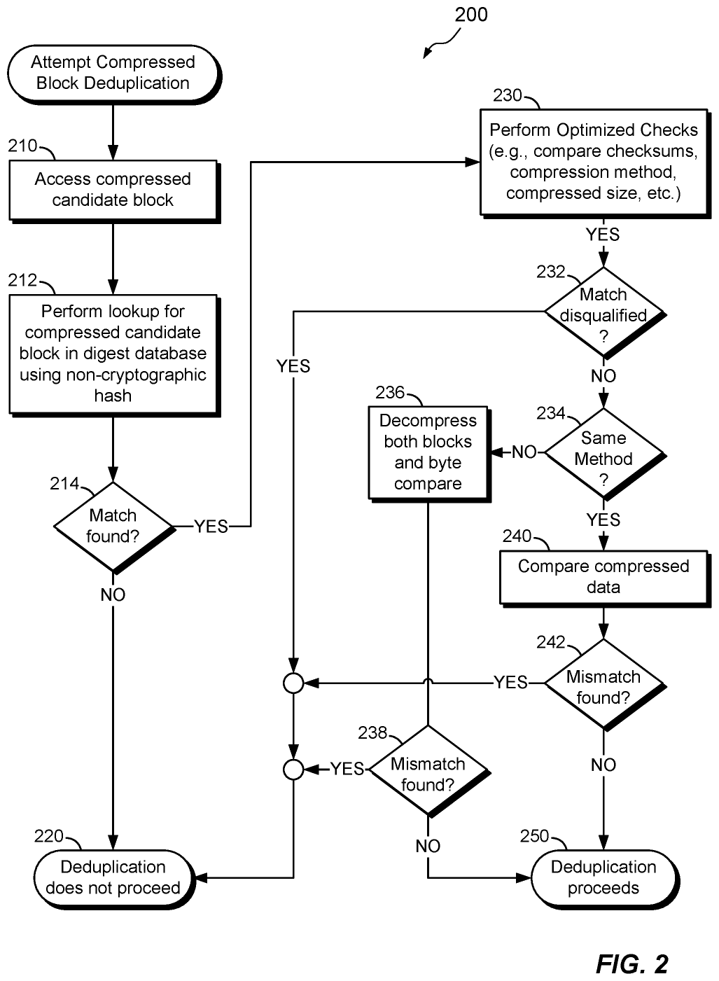

FIG. 2 shows an example method 200 of attempting deduplication and provides further details with regard to the activities described above. The method 200 may be performed, for example, by the deduplication facility 150, which is realized using instructions in the memory 130 of node 120a, which instructions are executed by the set of processors. The various acts of method 200 may be ordered in any suitable way. Accordingly, embodiments may be constructed in which acts are performed in orders different from that illustrated, which may include performing some acts simultaneously.

At 210, the deduplication facility 150 accesses a compressed candidate block 182a, e.g., a data block in storage 180 or in memory 130.

At 212, the deduplication facility 150 performs a lookup for the compressed candidate block 182a in the digest database 160 using a non-cryptographic hash function 170. For example, the deduplication facility 150 computes a hash value of the candidate block 182a using the non-cryptographic hash function 170 and attempts to match the computed hash value with a hash value in the digest database 160.

At 214, the deduplication facility 150 determines whether a match to a target block 182b is found, i.e., whether the lookup into the digest database 160 identifies an entry having the same hash value as the one computed for the candidate block 182a. If no match is found, then deduplication does not proceed and the method 200 terminates at 220. One should appreciate that any match at 214 is a preliminary match, as the non-cryptographic hash function 170 cannot provide a definitive answer as to whether the matching hash values indicate matching data.

If a preliminary match is found at 214, then operation proceeds to 230, whereupon the deduplication facility 150 performs optimized checks, e.g., checks of metadata associated with the candidate block 182a and the target block 182b, to determine whether the preliminary match can be promptly disqualified for deduplication. For example, the optimized checks may involve comparing checksums between the candidate block 182a and the target block 182b, comparing compressed sizes (assuming the same compression method is used), and the like.

At 232, the deduplication facility 150 determines whether the optimized checks disqualify a data match between the candidate block 182a and the target block 182b. If the optimized checks disqualify a true match, then operation proceeds to 220 and the attempt to deduplicate the candidate block 182a is abandoned.

But if the optimized checks fail to disqualify a data match, then operation proceeds instead to 234, whereupon the deduplication facility 150 determines whether the same compression method was used for both blocks 182a and 182b. If different compression methods were used for the two blocks, then no further shortcuts may be taken. Operation then proceeds to 236, where the deduplication facility 150 decompresses both blocks 182a and 182b (e.g., using the decompression methods identified in the metadata) and compares the decompressed data, e.g., byte for byte. Although act 236 can be time consuming and resource intensive, it is expected that act 236 is needed only rarely, as one or more disqualifying acts precede it. For instance, act 236 may be performed only when (1) there is a non-cryptographic hash match, (2) the checksums of the two blocks match, and (3) the two blocks were compressed using different compression methods.

At 238, the deduplication facility 150 determines whether the uncompressed data of the two blocks 182a and 182b match. If the uncompressed data do match, then the preliminary match is confirmed and operation proceeds to 250, whereupon deduplication takes place in the usual way, e.g., by storing the data of the candidate block 182a by reference to the data of the target block 182b. But if the data compared at 238 do not match, then the preliminary match is disqualified and operation proceeds instead to 220, whereupon the deduplication attempt is abandoned.

Returning to 234, if the compression method used for both the candidate block 182a and the target block 182 are the same, then the compressed data of the two blocks can be compared directly, and there is no need to decompress. The compressed data of the two blocks 182a and 182b may be compared in whole or in part, as any difference between the compressed data disqualifies a data match.

For example, operation may proceed to 240, whereupon the compressed data of the candidate block 182a are compared with the compressed data of the target block 182b. In some examples, the data of the two compressed blocks are compared incrementally, e.g., byte-by-byte or sector-by-sector (one sector equals 512 Bytes), in search of a mismatch. If any mismatch is found (at 242), then the preliminary match is disqualified and operation proceeds to 220. But if the two compressed blocks are compared entirely and no mismatch is found, then the two compressed blocks 182a and 182b are identical and operation proceeds to 250 (deduplication proceeds). It is not expected that act 240 would be resource-intensive, as both compressed blocks 182a and 182b are generally already in memory 130.

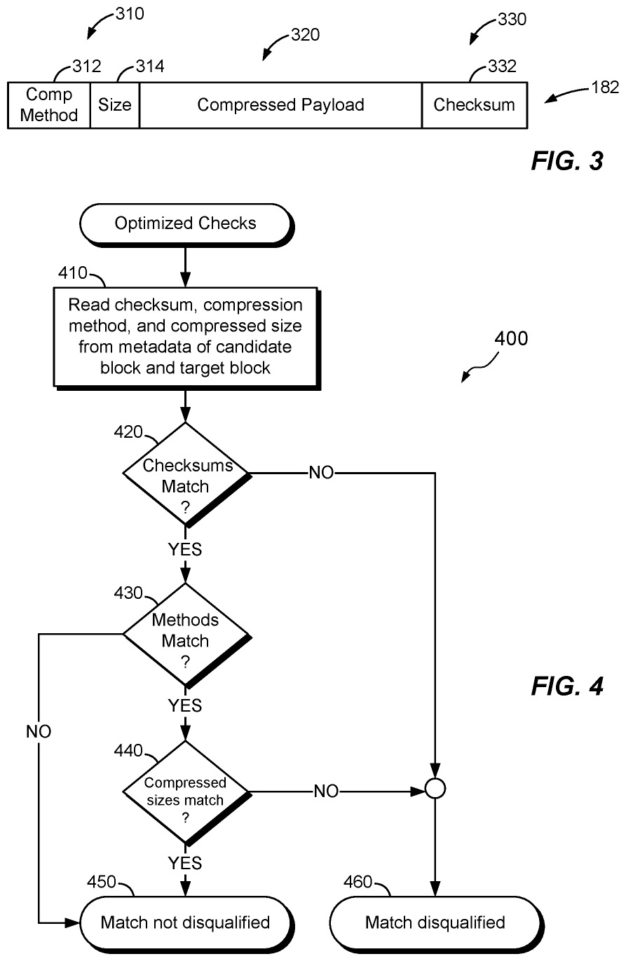

FIG. 3 shows an example layout of a compressed data block 180, which may be representative of both the candidate block 182a and the target block 182b. The example compressed data block 180 includes a header 310, a compressed payload (data) 320, and a footer 330. The header 310 may include a metadata element that identifies the compression method used to compress the payload 320. The header 310 may further include a size 314 of the compressed payload 320. As further shown, the footer 330 includes a checksum 332, such as a CRC (cyclic redundancy check), which preferably is computed from the uncompressed data block. In some examples, the header 310 and footer 330 may include additional metadata elements, or the positions of the depicted metadata elements may be exchanged between the header and footer.

Some of or all of the depicted metadata elements may be located elsewhere in the storage system 116, rather than or in addition to being in the header 310 or footer 330. For example, data blocks in the storage system 116 may be accessed by traversing a tree of mapping pointers, which terminates in leaf pointers. The leaf pointers represent logical data blocks. In some examples, leaf pointers point to virtual blocks, which in turn point to physical data (e.g., addresses in disk arrays). The leaf pointers and virtual blocks may provide convenient locations for storing the compression method 312, compressed size 314, checksum 332, and any other per-data-block metadata, as these structures represent the data blocks 180 and are typically loaded in to memory to enable the deduplication facility 150 to access the data blocks 180.

FIG. 4 shows an example method 400 of performing optimized checks and provides a more detailed view of the above-described act 230 of FIG. 2. At 410, the deduplication facility 150 reads metadata of the candidate block 182a and metadata of the target block 182b, such as the checksum 332, compression method 312, and compressed size 314 of each of the two data blocks. At 420, the deduplication facility 150 compares the checksum 332 of the candidate block 182a with the checksum 332 of the target block 182b. If the two checksums do not match (NO), then operation proceeds to 460 and the preliminary match (e.g., established at 214 of FIG. 2) is disqualified. If the two checksums 332 do match at 420 (YES), however, then operation proceeds to 430, whereupon the compression methods 312 are compared for the candidate block 182a and the target block 182b. If the two compression methods 312 are the same, then operation proceeds to 440, where compressed sizes of the two data blocks are compared. If the compressed sizes do not match (NO), then operation proceeds to 460 and the preliminary match is disqualified. However, if the compressed sizes match (YES), then operation proceeds to 450 and the preliminary match is not disqualified. Returning to 430, if the compression methods 312 for the candidate block 182a and the target block 182b do not match (NO), then there is no point in comparing compressed sizes and operation proceeds to 450 (match not disqualified). In this case, the additional acts of FIG. 2 will be relied upon to confirm or disqualify the match.

One should appreciate that the method 400 is merely an example of how optimized checks can be performed, given access to checksums, compression methods, and compressed sizes. Similar checks may be performed for other metadata elements that can readily identify mismatches. Thus, the method 400 is merely illustrative and is not intended to be limiting. To promote efficiency, simple and direct optimized checks are preferably performed before more complex checks, such that disqualification of preliminary checks can be achieved as early as possible during processing. This general guidance applies to the checks of FIG. 2 as well as to those of FIG. 4.

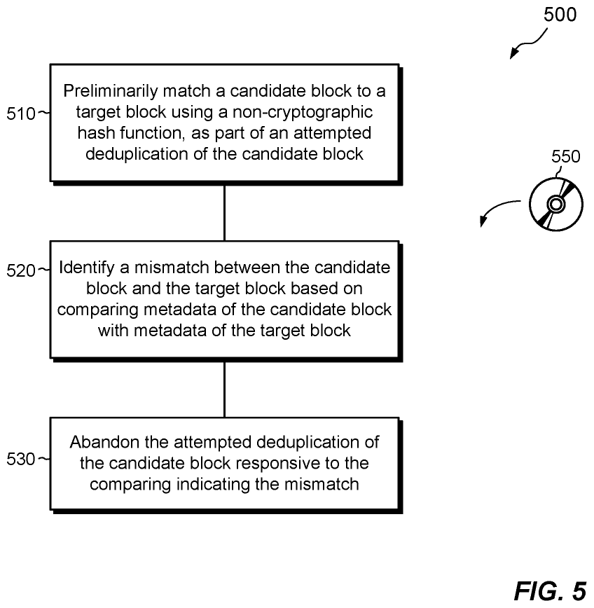

FIG. 5 shows an example method 500 of managing deduplication and provides a summary of some of the features described above. The method 500 may be performed, for example, by the software constructs shown in FIG. 1, which reside in the memory 130 of the node 120A and are run by the set of processors 124. The acts of method 500 may be performed in any suitable order, and some acts may be performed simultaneously.

At 510, a match is preliminarily made between a candidate block 182a and a target block 182b using a non-cryptographic hash function 170, as part of an attempted deduplication of the candidate block 182a.

At 520, a mismatch is identified between the candidate block 182a and the target block 182b based on comparing metadata (e.g., 312 and/or 332) of the candidate block 182a with metadata (e.g., 312 and/or 332) of the target block 182b.

At 530, the attempted deduplication of the candidate block 182a is abandoned responsive to the comparing indicating the mismatch. Instead of deduplicating the candidate block 182a, the candidate block instead may be stored (or may continue to be stored) independently of the target block 182b.

An improved technique has been described for managing deduplication using a non-cryptographic hash function 170. The technique includes obtaining metadata (e.g., 312 and/or 332) associated with both a candidate block 182a presented for deduplication and a target block 182b having a hash-based match to the candidate block 182a. The technique further includes checking for a mismatch between the candidate block 182a and the target block 182b based on the obtained metadata. In response to the checking determining a mismatch, the technique still further includes abandoning deduplication of the candidate block 182a, such that the candidate block 182a is stored independently of the target block 182b. Advantageously, the improved technique rapidly disqualifies many preliminary matches made using non-cryptographic hash-based comparisons, and thus operates faster and more efficiently than prior approaches, which may rely on data decompression and byte-for-byte comparisons.

Having described certain embodiments, numerous alternative embodiments or variations can be made. For example, although embodiments have been described for use with compressed data, other embodiments may be implemented for use with uncompressed data. For example, a hash-based preliminary match of uncompressed data blocks using a non-cryptographic hash function can be readily ruled out by comparing checksums or other metadata of the candidate and target blocks.

Also, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 550 in FIG. 5). Any number of computer-readable media may be used. The media may be encoded with instructions which, when executed on one or more computers or other processors, perform the process or processes described herein. Such media may be considered articles of manufacture or machines, and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of managing deduplication, comprising:
preliminarily matching a candidate block to a target block using a non-cryptographic hash function, as part of an attempted deduplication of the candidate block;
identifying a mismatch between the candidate block and the target block based on comparing metadata of the candidate block with metadata of the target block; and
abandoning the attempted deduplication of the candidate block responsive to the comparing indicating the mismatch.

2. The method of claim 1, wherein comparing the metadata includes determining whether a checksum of the candidate block matches a checksum of the target block, the comparing configured to indicate the mismatch responsive to the checksum of the candidate block not matching the checksum of the target block.

3. The method of claim 2, wherein the candidate block and the target block are both compressed blocks, and wherein the checksum of the candidate block and the checksum of the target block are included within respective footers of the compressed blocks.

4. The method of claim 2, wherein the checksum of the candidate block and the checksum of the target block are each computed based on uncompressed data of the candidate block and the target block, respectively.

5. The method of claim 1, wherein the candidate block and the target block are both compressed blocks, and wherein comparing the metadata of the candidate block with the metadata of the target block includes:
identifying, from the metadata of the candidate block, a first compression method used to compress the candidate block and a first compressed size of the candidate block;
identifying, from the metadata of the target block, a second compression method used to compress the target block and a second compressed size of the target block; and
in response to determining that the first compression method matches the second compression method, determining whether the first compressed size matches the second compressed size, the comparing configured to indicate the mismatch responsive to the first compression method matching the second compression method but the first compressed size not matching the second compressed size.

6. The method of claim 1, wherein comparing the metadata of the candidate block with the metadata of the target block includes both (i) determining whether a checksum of the candidate block matches a checksum of the target block, and (ii) determining whether a compressed size of the candidate block matches a compressed size of the target block, the comparing configured to indicate the mismatch responsive to at least one of (i) the checksum of the candidate block not matching the checksum of the target block or (ii) the compressed size of the candidate block not matching the compressed size of the target block.

7. The method of claim 1, further comprising:
preliminarily matching a second candidate block to a second target block using the non-cryptographic hash function, as part of an attempted deduplication of the second candidate block;
further preliminarily matching the second candidate block with the second target block by determining that metadata of the second candidate block matches metadata of the second target block;
comparing a set of compressed data of the second candidate block with a corresponding set of compressed data of the second target block; and
abandoning the attempted deduplication of the second candidate block responsive to the set of compressed data of the second candidate block failing to match the corresponding set of compressed data of the second target block.

8. The method of claim 1, further comprising:
preliminarily matching a second candidate block to a second target block using the non-cryptographic hash function, as part of an attempted deduplication of the second candidate block, the second candidate block and the second target block both being compressed;
determining that a compression method used for compressing the second candidate block matches a compression method used for compressing the second target block; and
confirming a true match between the second candidate block and the second target block responsive to a compressed-data match between the second candidate block and the second target block.

9. The method of claim 1, wherein comparing metadata of the candidate block with metadata of the target block includes comparing metadata that deterministically provides identical results for identical data.

10. A computerized apparatus, comprising control circuitry that includes a set of processors coupled to memory, the control circuitry constructed and arranged to:
preliminarily match a candidate block to a target block using a non-cryptographic hash function, as part of an attempted deduplication of the candidate block;
identify a mismatch between the candidate block and the target block based on comparing metadata of the candidate block with metadata of the target block; and
abandon the attempted deduplication of the candidate block responsive to the comparing indicating the mismatch.

11. The computerized apparatus of claim 10, wherein the control circuitry constructed and arranged to compare metadata of the candidate block with metadata of the target block is further constructed and arranged to compare metadata that deterministically provides identical results for identical data.

12. The computerized apparatus of claim 9, wherein the control circuitry constructed and arranged to compare the metadata of the candidate block with the metadata of the target block is further constructed and arranged to both (i) to determine whether a checksum of the candidate block matches a checksum of the target block, and (ii) to determine whether a compressed size of the candidate block matches a compressed size of the target block.

13. A computer program product including a set of non-transitory, computer-readable media having instructions which, when executed by control circuitry of a computerized apparatus, cause the computerized apparatus to perform a method of managing deduplication, the method comprising:
preliminarily matching a candidate block to a target block using a non-cryptographic hash function, as part of an attempted deduplication of the candidate block;
identifying a mismatch between the candidate block and the target block based on comparing metadata of the candidate block with metadata of the target block; and
abandoning the attempted deduplication of the candidate block responsive to the comparing indicating the mismatch.

14. The computer program product of claim 13, wherein comparing the metadata includes determining whether a checksum of the candidate block matches a checksum of the target block.

15. The computer program product of claim 14, wherein the candidate block and the target block are both compressed blocks, and wherein the checksum of the candidate block and the checksum of the target block are included within respective footers of the compressed blocks.

16. The computer program product of claim 14, wherein the checksum of the candidate block and the checksum of the target block are each computed based on uncompressed data of the candidate block and the target block, respectively.

17. The computer program product of claim 13, wherein the candidate block and the target block are both compressed blocks, and wherein comparing the metadata of the candidate block with the metadata of the target block includes:
identifying, from the metadata of the candidate block, a first compression method used to compress the candidate block and a first compressed size of the candidate block;
identifying, from the metadata of the target block, a second compression method used to compress the target block and a second compressed size of the target block; and
in response to determining that the first compression method matches the second compression method, determining whether the first compressed size matches the second compressed size.

18. The computer program product of claim 13, wherein comparing the metadata of the candidate block with the metadata of the target block includes both (i) determining whether a checksum of the candidate block matches a checksum of the target block, and (ii) determining whether a compressed size of the candidate block matches a compressed size of the target block.

19. The computer program product of claim 13, wherein the method further comprises
preliminarily matching a second candidate block to a second target block using the non-cryptographic hash function, as part of an attempted deduplication of the second candidate block;
further preliminarily matching the second candidate block with the second target block by determining that metadata of the second candidate block matches metadata of the second target block;
comparing a set of compressed data of the second candidate block with a corresponding set of compressed data of the second target block; and
abandoning the attempted deduplication of the second candidate block responsive to the set of compressed data of the second candidate block failing to match the corresponding set of compressed data of the second target block.

20. The computer program product of claim 13, wherein comparing metadata of the candidate block with metadata of the target block includes comparing metadata that deterministically provides identical results for identical data.
